(19) United States
(12) Patent Application Publication
(10) Pub. No.: US 2004/0085631 A1
(43) Pub. Date: May 6, 2004

(54) Method for providing a structure

(76) Inventor: Norbert Mueller, Asslar (DE)

Correspondence Address: WELLS ST. JOHN P.S., 601 W. FIRST AVENUE, SUITE 1300, SPOKANE, WA, 99201, US

(21) Appl. No.: 10/688,827

(22) Filed: Oct. 17, 2003

(30) Foreign Application Priority Data
Oct. 17, 2002 (DE) 102 48 524.0

(51) Int. Cl. G02B 23/00

(52) U.S. Cl. 359/407

(57) ABSTRACT

The invention relates to a method for providing a structure (2d) in the form of a crosshair and/or hairlines in a telescopic sight or binocular telescope, at least one transparent optical part (1d), in particular a lens of the telescopic sight or binocular telescope, being provided with the structure (2d). The structure (2d) is introduced as internal engraving into the transparent optical part (1d) by laser action.

### BACKGROUND OF THE INVENTION

1. Field of the Invention

The invention relates to a method for providing a structure in the form of a crosshair and/or hairlines in a telescopic sight or binocular telescope, at least one transparent optical part, in particular a lens of the telescopic sight or binocular telescope, being provided with the structure. The invention additionally relates to a telescopic sight or binocular telescope having transparent optical parts, at least one transparent optical part, in particular a lens, being provided with a structure in the form of a crosshair and/or hairlines.

2. Description of the Related Art

In order to introduce hairlines or crosshairs into telescopic sights or binocular telescopes, hitherto use has been made of glass to which an electrodeposited layer is applied. Avoiding contaminants which can prevent complete application of the electrodeposited layer is problematic in this case. Said glass is subsequently introduced into the telescope. Furthermore, it is possible to introduce crosshair-like structures by etching into the glass.

Mounting the crosshairs/hairlines into the telescopes proves to be difficult and complicated since it is necessary to work very precisely and carefully. Contaminants must also be avoided here, too, of course.

### SUMMARY OF THE INVENTION

The present invention is therefore based on the object of providing a method and a telescopic sight or binocular telescope of the type mentioned in the introduction which solve the disadvantages of the prior art, the intention being, in particular, to achieve a high precision and to enable simple mounting in the course of the introduction of the crosshair/hairline.

This object is achieved according to the invention by virtue of the fact that the structure is introduced as internal engraving into the transparent optical part by laser action.

With regard to the telescopic sight or binocular telescope, comprising transparent optical parts, the object is achieved by means of at least one transparent optical part being provided with a structure, wherein said structure is introduced as internal engraving into said transparent optical part.

These measures enable simple, clean and precise assembly of the telescopic sight. Etching or application of an electrodeposited layer to the optical part can be dispensed with, as a result of which faults on account of contaminants are avoided from the outset in a simple and advantageous manner.

The invention may furthermore provide for the structure to be adapted to the image field curvature of the telescopic sight or binocular telescope.

As a result, the structure can easily be matched from the outset to the required image field curvature of the respective telescopic sight or binocular telescope without the transparent optical part which carries the structure itself having to be adapted.

Advantageous refinements and developments of the invention emerge from the exemplary embodiments which are described in principle below with reference to the drawing.

### BRIEF DESCRIPTION OF THE DRAWINGS

FIG. 1a shows a transparent optical part according to the prior art into which a structure is introduced by etching;

FIG. 1b shows a transparent optical part according to the prior art into which a structure is introduced by application of an electrodeposited layer;

FIG. 2 shows a transparent optical part in which a structure has been introduced by the method according to the invention; and

FIG. 3 shows a transparent optical part in which a structure has been introduced by the method according to the invention and adapted to an image field curvature.

### DETAILED DESCRIPTION

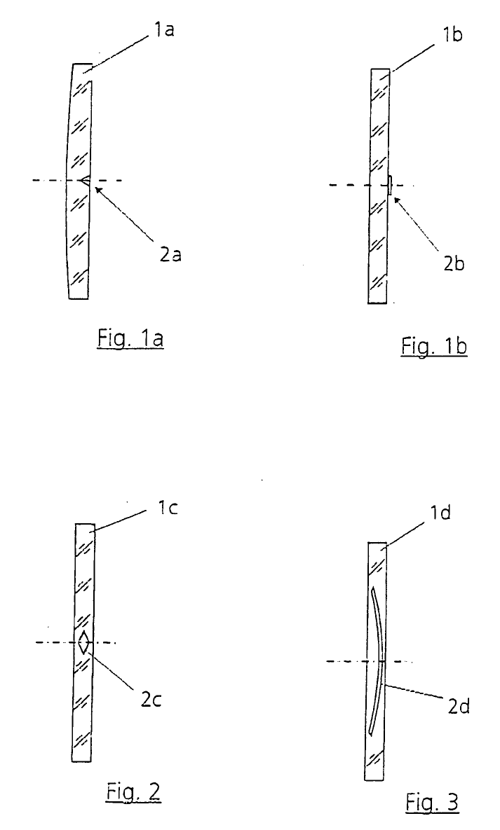

As can be seen from FIG. 1a, in the prior art, a glass 1a has an etched hairline or crosshair structure 2a. The glass is introduced into a telescopic sight or binocular telescope (not illustrated) in order to produce a hairline or a crosshair in the beam path for the observer. The optical axis is indicated in principle as a dash-dot line in this case. What is highly disadvantageous in this case is that contaminants which impair the quality of the crosshair often occur during the conventional etching process. In FIG. 1b, as further prior art, a hairline or crosshair structure has been applied to the glass 1b as an electrodeposited layer 2b. Mounting the glass 1b into the telescopic sight proves to be very difficult since it is necessary to avoid contaminants caused by the electrodeposition process. At the same time, care must be taken to ensure that no parts of the electrodeposited layer are detached in the course of mounting.

As can be seen from FIG. 2, which relates to the invention, a hairline or crosshair structure 2c is introduced into a glass 1c as internal engraving by laser action.

The method of operation and function of the laser engraving technology used is generally known, for which reason it is not discussed in detail below. By way of example, when a laser beam of sufficiently high power density is focused into the interior of a transparent solid, on account of nonlinear optical effects, localized absorption occurs at the laser focus. In this case, the concentrated input of energy results in locally narrowly delimited cracking. Such microcracks appear as bright points owing to their scattering behavior. Desired structures can be built up point by point in the workpiece through suitable 2D or 3D relative movement of workpiece and laser beam and by synchronization between the movement sequence and the laser pulses.

By virtue of the internal laser engraving, contaminants are avoided from the outset in a simple and advantageous manner. Furthermore, the structure 2c cannot be damaged in the course of mounting into the telescope.

In FIG. 3, a crosshair structure 2d has been introduced into a glass 1d by internal laser engraving, the structure 2d simultaneously having been adapted to the image field curvature required in the telescopic sight.

What is claimed is:

1. A method for providing a structure in a telescopic sight or binocular telescope, comprising at least one transparent optical part of the telescopic sight or binocular telescope, being provided with said structure, wherein said structure is introduced as internal engraving into said transparent optical part by laser action.

2. The method as claimed in claim 1, wherein said structure is adapted to the image field curvature of the telescopic sight or binocular telescope.

3. The method as claimed in claim 1, wherein said structure is a crosshair.

4. The method as claimed in claim 1, wherein said structure is in form of hairlines.

5. The method as claimed in claim 1, wherein said transparent optical part is a lens.

6. A telescopic sight or binocular comprising transparent optical parts, wherein at least one transparent optical part being provided with a structure, wherein said structure is introduced as internal engraving into said transparent optical part.

7. The telescopic sight or binocular telescope of claim 6, wherein said structure is a crosshair.

8. The telescopic sight or binocular telescope of claim 6, wherein said structure is in form of hairlines.

9. The telescopic sight or binocular telescope of claim 6, wherein said transparent optical part is a lens.
